(19) United States
(12) Patent Application Publication
(10) Pub. No.: US 2016/0344097 A1
(43) Pub. Date: Nov. 24, 2016

(54) MOBILE TERMINAL SWITCHING ANTENNA AND SWITCHING METHOD THEREOF

(71) Applicant: JRD COMMUNICATION INC., Shenzhen, Guangdong (CN)

(72) Inventors: LINGJIAN PAN, Shenzhen City, Guangdong (CN); Jingjing LI, Shenzhen City, Guangdong (CN)

(21) Appl. No.: 14/906,172

(22) PCT Filed: May 6, 2015
(86) PCT No.: PCT/CN2015/078419

§ 371 Date: Jan. 19, 2016

(30) Foreign Application Priority Data
Dec. 1, 2014 (CN) 201410711405.6

(51) Int. Cl. H01Q 3/24; H01Q 1/48; H04W 72/04; H01Q 1/24; H04W 8/06

(52) U.S. Cl. CPC H01Q 3/247; H01Q 1/243; H04W 8/06; H04W 72/0453; H01Q 1/48

(57) ABSTRACT

A mobile terminal switching antenna and a switching method thereof include an antenna, RF module, baseband chip, voltage dividing module, noise barrier module, DC blocking module, unidirectional conduction module, and antenna matching module. The baseband chip is coupled to the antenna via the RF module. The baseband chip is coupled to the antenna sequentially via the voltage dividing module, noise barrier module, and DC blocking module. The baseband chip is grounded sequentially via the voltage dividing module, noise barrier module, unidirectional conduction module, and antenna matching module. By the baseband chip not emitting or emitting the control signal to the antenna, the switching of the operative states of the antenna is thus realized, and the range of the frequency bands which can be received by the antenna is changed correspondingly, thereby greatly enhancing the receiving and transmitting performances and providing convenience to users.

### TECHNICAL FIELD OF THE INVENTION

The present invention relates to a mobile terminal antenna technology, and in particular to a mobile terminal switching antenna and a switching method thereof.

### BACKGROUND OF THE INVENTION

With the development of communication technology, mobile phones have become essential equipment for people. LTE (Long Term Evolution, commonly known as 4G) mobile phone technology has become an indispensable technical requirement for new mobile phones. However, LTE frequency bands are varied, and the frequency range is designed from 700 MHz to 2.7 GHz. This requires an increasingly high bandwidth of a mobile phone antenna, such that it becomes more difficult to research and develop the mobile phone antenna.

The LTE frequency bands are coming with a wider frequency range, and there is the frequency range of 700 MHz and more than 2.5 GHz. This raises the requirement of the antenna: a greater bandwidth which takes into account the efficiency of the antenna. If the bandwidth is not wide enough, and the antenna itself is not efficient, the mobile phone itself cannot get a proper transfer rate. The antenna itself is a physical structure, and its efficiency relates to the environment thereof. Current mobile phones are becoming thinner; as their functionality increases, their components also increase. The surrounding environment of the mobile phone antenna also deteriorates (the devices near the antenna increase, and the space becomes smaller). These will influence the efficiency of the antenna, thereby reducing user experience (slow download speed and increased power consumption).

Thus, there is a need to improve and develop the prior art.

### SUMMARY OF THE INVENTION

A technical problem which the present invention needs to solve is to provide a mobile terminal switching antenna and a switching method thereof for the above-mentioned disadvantage of the prior art. An objective of the present invention is to provide a new type of switching antenna, which can achieve that the antenna can work in different frequency bands at a lower cost and has a good antenna performance at the same time, thereby obtaining a greater bandwidth and higher efficiency in a limited space inside the mobile phone.

A technical solution of the present invention is implemented as follows.

A mobile terminal switching antenna includes: an antenna; a radio-frequency (RF) module; a baseband chip utilized to provide a control signal; a voltage dividing module utilized to perform voltage division for the control signal; a noise barrier module utilized to perform noise barrier for the control signal; a DC blocking module utilized to block a DC signal from entering the antenna; a unidirectional conduction module utilized to unidirectionally conduct the control signal; an antenna matching module utilized to match and debug the antenna while switching the antenna; the baseband chip coupled to the antenna via the RF module; the baseband chip coupled to the antenna sequentially via the voltage dividing module, the noise barrier module, and the DC blocking module; and the baseband chip being grounded sequentially via the voltage dividing module, the noise barrier module, the unidirectional conduction module, and the antenna matching module.

In the mobile terminal switching antenna, the voltage dividing module includes a first resistor, and the baseband chip is coupled to the noise barrier module via the first resistor.

In the mobile terminal switching antenna, the noise barrier module includes a first capacitor and a first inductor; the voltage dividing module is coupled to the DC blocking module via the first inductor, and the voltage dividing module is grounded via the first capacitor.

In the mobile terminal switching antenna, the DC blocking module includes a second capacitor. One end of the second capacitor is coupled to the noise barrier module and the unidirectional conduction module, and the other end of the second capacitor is coupled to the antenna.

In the mobile terminal switching antenna, the unidirectional conduction module includes a radio-frequency (RF) diode. An anode of the RF diode is respectively coupled to the noise barrier module and the DC blocking module, and a cathode of the RF diode is coupled to the antenna matching module.

In the mobile terminal switching antenna, the antenna matching module includes a second inductor. One end of the second inductor is coupled to the unidirectional conduction module, and the other end is grounded.

In the mobile terminal switching antenna, the antenna has a switching point; one end of the switching point is coupled to the antenna, and the other end is coupled to the DC blocking module.

In the mobile terminal switching antenna, when the baseband chip does not output the control signal, the antenna is in a first operative state which comprises a plurality of working frequency bands; when the baseband chip outputs the control signal, the antenna is in a second operative state which comprises another plurality of working frequency bands.

A switching method adopting the mobile terminal switching antenna includes the following steps of:

A. receiving the radio-frequency signal given a base station and scanning each frequency band by a base station and scanning each frequency band by a mobile terminal;

B. determining whether the currently scanned frequency band is in a plurality of working frequency bands comprised in a first operative state, which the antenna is in, when the baseband chip does not output the control signal, if so, then performing step C; if not, then performing step D;

C. working in the first operative state by the antenna of the mobile terminal, and when the radio-frequency signal which is given by the base station and received by the mobile terminal is consistent with information of the frequency band of an operator desired by a SIM card of the mobile terminal, registering to a network for the mobile terminal working properly;

D. outputting the control signal by the baseband chip, the antenna of the mobile terminal being in a second operative state which comprises another plurality of working frequency bands, and scanning each of the frequency bands individually by the mobile terminal, when the radio-frequency signal which is given by the base station and received by the mobile terminal is consistent with the information of the frequency band of the operator desired by the SIM card of the mobile terminal, registering to the network for the mobile terminal working properly.

The mobile terminal switching antenna and the switching method thereof provided by the present invention effectively solve the problems that the bandwidth of the prior art mobile terminal antenna is not wide enough, the antenna itself is inefficient, and the mobile terminal itself cannot get a proper transmission rate. They include an antenna; an RF module; a baseband chip utilized to provide a control signal; a voltage dividing module utilized to perform voltage division for the control signal; a noise barrier module utilized to perform noise barrier for the control signal; a DC blocking module utilized to block a DC signal from entering the antenna; a unidirectional conduction module utilized to unidirectionally conduct the control signal; an antenna matching module utilized to match and debug the antenna while switching the antenna; the baseband chip coupled to the antenna via the RF module; the baseband chip coupled to the antenna sequentially via the voltage dividing module, the noise barrier module, and the DC blocking module; and the baseband chip being grounded sequentially via the voltage dividing module, the noise barrier module, the unidirectional conduction module, and the antenna matching module. By the baseband chip not emitting or emitting the control signal to the antenna, the switching of the operative states of the antenna is thus realized, and the range of the frequency bands which can be received by the antenna is changed correspondingly, thereby greatly enhancing the receiving and transmitting performances of the mobile terminal antenna. Based on the enhancement of the receiving performance, users can still receive the signal well from the base station for calls in a place far from the base station, and based on the enhancement of the receiving performance, the operating current of the RF transmission of the mobile terminal can be reduced to allow the battery to work longer, making the mobile terminal cooler, and providing convenience for the users.

### BRIEF DESCRIPTION OF THE DRAWINGS

FIG. 1 is a schematic drawing illustrating a prior art mobile terminal antenna;

FIG. 2 is a block diagram illustrating a mobile terminal switching antenna according to a preferred embodiment of the present invention; and

FIG. 3 is a flow chart illustrating a switching method of the mobile terminal switching antenna according to a preferred embodiment of the present invention.

### DETAILED DESCRIPTION OF THE INVENTION

The present invention provides a mobile terminal switching antenna and a switching method thereof. To make the objectives, technical solutions, and advantages of the present disclosure clearer, the present disclosure will be further described hereinbelow with reference to the attached drawings and embodiments thereof. It should be understood that the specific embodiments described herein are merely utilized to explain the present invention but not to limit the present invention.

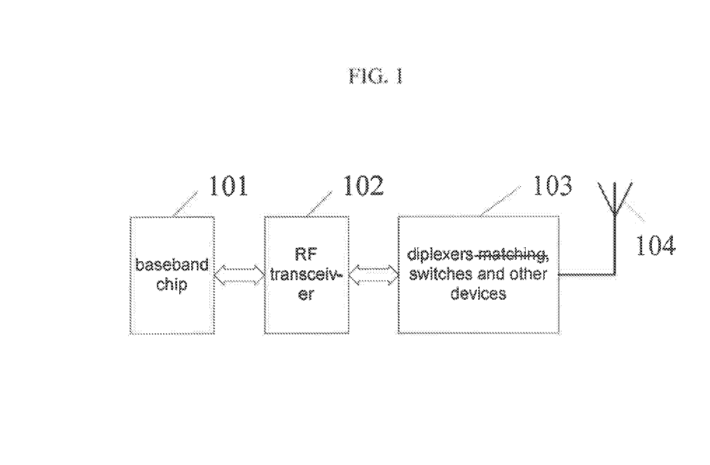

Refer to FIG. 1, which is a schematic drawing illustrating a prior art mobile terminal antenna. As shown in the drawing, the prior art mobile terminal antenna includes a baseband chip 101, an RF (Radio Frequency) transceiver 102, amplifiers, diplexers matching, switches, and other devices 103, and an antenna 104. The antenna 104, which is utilized as a structural component or a physical element, is utilized as a passive device to be directly connected to the RF module for transmitting and receiving signals. The baseband chip 101 encodes and modulates voice and data information collected or generated by the mobile terminal and transmits it to the RF transceiver 102, and then it is converted into a radio-frequency signal by the RF transceiver 102. After passing through the diplexers matching, switches, and other devices 103, it is radiated out via the antenna 104. This is the principle of the antenna of the conventional mobile terminal, and it belongs to the prior art. It will not be described in detail herein.

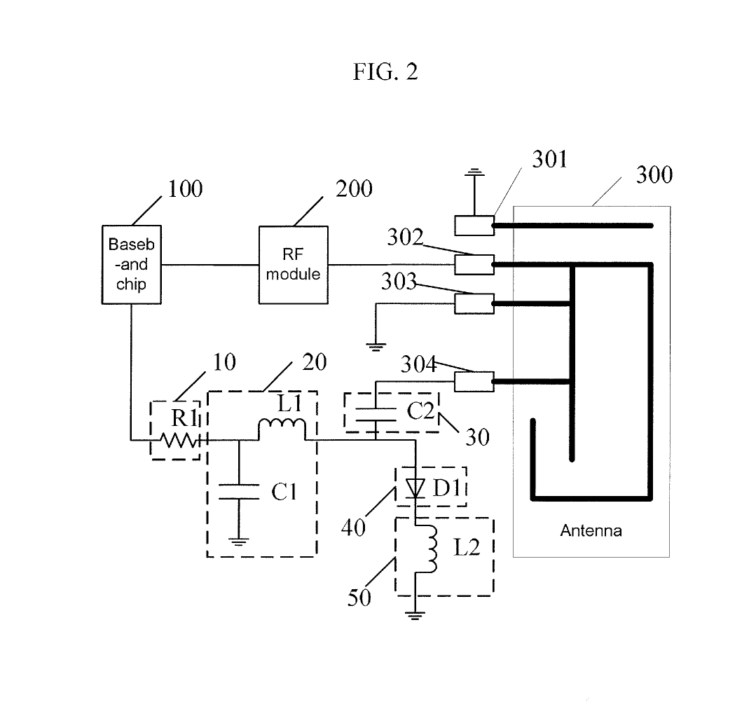

Refer to FIG. 2, which is a block diagram illustrating a mobile terminal switching antenna according to a preferred embodiment of the present invention. As shown in the drawing, the mobile terminal switching antenna provided by the present invention includes: an antenna 300; an RF module 200; a baseband chip 100 utilized to provide a control signal; a voltage dividing module 10 utilized to perform voltage division for the control signal; a noise barrier module 20 utilized to perform noise barrier for the control signal; a DC blocking module 30 utilized to block a DC signal from entering the antenna; a unidirectional conduction module 40 utilized to unidirectionally conduct the control signal; an antenna matching module 50 utilized to match and debug the antenna while switching the antenna;

the baseband chip 100 coupled to the antenna 300 via the RF module 200; the baseband chip 100 coupled to the antenna 300 sequentially via the voltage dividing module 10, the noise barrier module 20, and the DC blocking module 30; and the baseband chip 100 being grounded sequentially via the voltage dividing module 10, the noise barrier module 20, the unidirectional conduction module 40, and the antenna matching module 50.

Specifically, the RF module 200 is the RF (Radio Frequency) transceiver, the amplifiers, diplexers matching, switches and other devices as described in FIG. 1. The baseband chip 100 and the antenna 300 are the components of the mobile terminal. The present invention adds a circuit to supply power to the antenna based on the conventional antenna. That is, the baseband chip 100 is coupled to the antenna 300 sequentially via the voltage dividing module 10, the noise barrier module 20, and the DC blocking module 30. The baseband chip 100 is grounded sequentially via the voltage dividing module 10, the noise barrier module 20, the unidirectional conduction module 40, and the antenna matching module 50, so that when the baseband chip 100 does not output the control signal, the antenna 300 is in a first operative state which comprises a plurality of working frequency bands; when the baseband chip 100 outputs the control signal, the antenna 300 is in a second operative state which comprises another plurality of working frequency bands. That is to say, when the baseband chip 100 does not emit or does emit the control signal respectively, the antenna 300 has the different working frequency bands correspondingly. The present invention realizes the switching of the antenna by means of controlling whether the baseband chip 100 emits the control signal or not, thereby greatly enhancing the receiving and transmitting performances of the mobile terminal antenna. Based on the enhancement of the receiving performance, users can still receive the signal well from the base station for calls in a place far from the base station, and based on the enhancement of the receiving performance, the operating current of the RF transmission of the mobile terminal can be reduced to allow the battery to work longer and to make the mobile terminal cooler.

Refer to FIG. 2 again, specifically, the voltage dividing module 10 includes a first resistor R1; the baseband chip 100 is coupled to the noise barrier module 20 via the first resistor R1. In actual application, the role of the first resistor R1 is to divide voltage for avoiding the voltage of the control signal given by the baseband chip 100 to be too high and to impact other devices. The general value thereof is about 50 to 100 ohms.

Furthermore, the noise barrier module 20 includes a first capacitor C1 and a first inductor L1; the voltage dividing module 10 is coupled to the DC blocking module 30 via the first inductor L1; and the voltage dividing module 10 is grounded further via the first capacitor C1. The role of the first capacitor C1 is to eliminate the noise of the control signal for avoiding affecting the antenna and to make noise directly go to the ground, and the general value thereof is about 33 to 100 picofarads (pf). The role of the first inductor L1 which is similar to that of the first capacitor C1 is to prevent the noise from passing. The general value of about 40 to 100 nanohenrys (nh).

Furthermore, the DC blocking module 30 includes a second capacitor C2. One end of the second capacitor C2 is coupled to the noise barrier module 20 and the unidirectional conduction module 40, and the other end of the second capacitor C2 is coupled to the antenna 300.

The unidirectional conduction module comprises an RF diode D1. An anode of the RF diode D1 is respectively coupled to the noise barrier module 20 and the DC blocking module 30, and a cathode of the RF diode D1 is coupled to the antenna matching module 50.

The antenna matching module 50 includes a second inductor L2. One end of the second inductor L2 is coupled to the unidirectional conduction module, and the other end is grounded.

Specifically, the role of the second capacitor C2 is to prevent a DC signal from passing, to avoid it from entering the antenna 300 and let it go to the ground via the RF diode D1 and the second inductor L2. The role of the RF diode D1 is to be in a straight-through state when the control signal passes through it, so that the signal passes through the RF diode D1 and the second inductor L2 to the ground for forming a loop. The role of the second inductor L2 is to be utilized as match debugging of the antenna when the switching works, and the general value thereof is about 8 nh˜20 nh.

Referring to the circuit diagram shown in FIG. 2 again, the control signal is output from a GPIO (General Purpose Input Output, referred to as GPIO or bus extender, a function provided here is a control function) port. The GPIO control signal output from the baseband chip 100 does not flow through the second capacitor C2 and into the antenna 300. The noise contained therein will be obstructed by the first inductor L1 and directly grounded via the first capacitor at the same time.

While the antenna 300 is in a signal transmitting state, the radio-frequency signal goes to the antenna 300 from the RF module 200. While the control signal makes the RF diode D1 be in an open state, the current on the antenna 300 passes through the RF diode D1, and does not enter the baseband chip 100 because of the obstruction effect of the first inductor L1.

In the process of practice application, the mobile terminal is a mobile phone. Since the radio frequency of the phone antenna is high, at 700 MHz or more, and the control signal of the baseband chip 100 is a DC signal (with high-frequency noise), the electrical signal always flows through the minimum impedance and then to the ground. Then the DC signal will not go through the second capacitor C2, but through the first inductor L1, the RF diode D1 and the second inductor L2 to ground. The noise goes through the first capacitor C1 to the ground, and the signal of the antenna goes through the second capacitor C2, the RF diode D1 and the second inductor L2 to the ground, so as not to affect the receiving and emitting of the radio-frequency signal.

Referring to FIG. 2 again, in the prior art, the antenna 300 typically has a feed point 302 and two ground points. The two ground points herein are a first ground point 301 and a second ground point 303 respectively. The first ground point 301 is utilized as a parasitic antenna for increasing the operating bandwidth of the antenna. This belongs to the prior art. Certainly, the prior art mobile terminal antenna may also have only one feed point and one ground point. On these bases, the present invention is to add a switching point 304. One end of the switching point 304 is coupled to the antenna 300; another end thereof is coupled to the second capacitor C2 and connected to the ground sequentially via the second capacitor C2, the RF diode D1, and the second inductor L2. Meanwhile, the other end is coupled to the baseband chip 100 via the first inductor L1, the first capacitor C1, and the first resistor R1, in which the first capacitor C1 is grounded.

In the mobile terminal switching antenna provided by the present invention, when the baseband chip 100 does not output the control signal, the antenna 300 is in a first operative state which comprises a plurality of working frequency bands; when the baseband chip 100 outputs the control signal, the antenna 300 is in a second operative state which comprises another plurality of working frequency bands. That is to say, when the baseband chip 100 does not output the control signal to the first resistor R1, the antenna 300 is in the first operative state. The first operative state includes the plurality of working frequency bands. When the baseband chip 100 outputs the control signal to the first resistor R1 and finally to the antenna 300, the antenna 300 is in the second operative state. The second operative state includes another plurality of working frequency bands. The working frequency bands are different from those of the first operative state. Accordingly, the mobile terminal switching antenna of the present invention can work in more frequency bands. The antenna can cover more of the frequency bands and is more effective.

The mobile terminal switching antenna provided by the present invention can allow the antenna to work in different frequency bands at a lower cost and has a good antenna performance at the same time, thereby obtaining a greater bandwidth and higher efficiency in a limited space inside the mobile phone. This realizes the RF antenna of the mobile terminal working in a larger frequency range and provides a higher antenna efficiency. Although many existing chips also provide a dynamically adjustable antenna, the chips are expensive, and the circuits thereof are more complex, resulting in an increased debugging difficulty. The present invention is relatively more concise, and the cost is very low relative to the chips. The debugging is relatively simple, and the debugging effect is even higher than that of the chips. It has reference significance and provides convenience to the users.

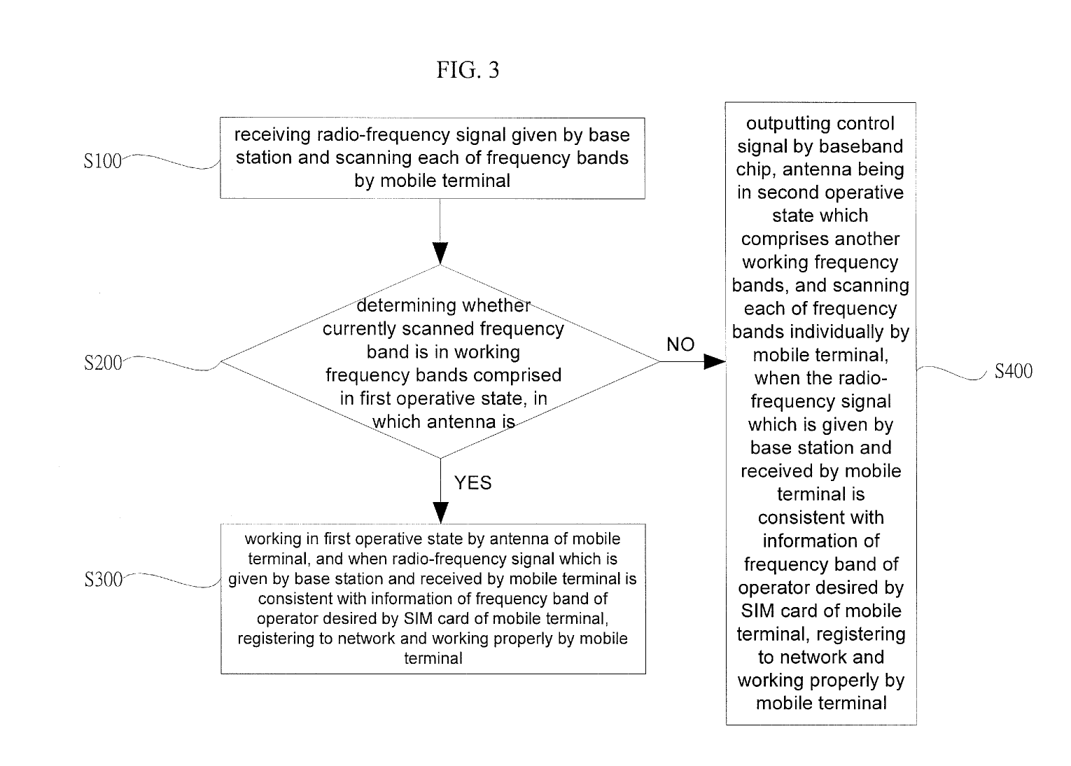

Based on the above-mentioned mobile terminal switching antenna, the present invention further provides a switching method of the mobile terminal switching antenna. As shown in FIG. 3, the method includes the following steps of:

step S100, receiving the radio-frequency signal given a base station and scanning each frequency band by a base station and scanning each frequency band by a mobile terminal;

step S200, determining whether the currently scanned frequency band is in a plurality of working frequency bands comprised in a first operative state, which the antenna is in, when the baseband chip does not output the control signal, if so, then performing step S300; if not, then performing step S400;

step S300, working in the first operative state by the antenna of the mobile terminal, and when the radio-frequency signal which is given by the base station and received by the mobile terminal is consistent with information of the frequency band of an operator desired by a SIM card of the mobile terminal, registering to a network for the mobile terminal working properly;

step S400, outputting the control signal by the baseband chip, the antenna of the mobile terminal being in a second operative state which comprises another plurality of working frequency bands, and scanning each of the frequency bands individually by the mobile terminal, when the radio-frequency signal which is given by the base station and received by the mobile terminal is consistent with the information of the frequency band of the operator desired by the SIM card of the mobile terminal, registering to the network for the mobile terminal working properly.

Specifically, after the phone is switched on, it will start scanning the frequency bands one by one and receive the radio-frequency signal given by the base station in space. Meanwhile, the baseband chip is aware of the information of the currently scanned frequency band, and determines whether the currently scanned frequency band is in the working frequency bands comprised in the first operative state, which the antenna is in, when the baseband chip does not output the control signal. If the antenna is in the first operative state, then the baseband chip does not output the GPIO control signal, and then mobile terminal antenna works in the correct first operative state. When the radio-frequency signal which is given by the base station and received by the mobile terminal is consistent with the information of the frequency band of the operator desired by the SIM card of the mobile terminal, registering to the network for the mobile terminal working properly.

When the scanned frequency band is not in the first operative state, then the mobile terminal antenna is switched to the second operative state. The base station chip emits the GPIO control signal for switching the antenna working in the second operative state. In such scanning one by one, when the radio-frequency signal received by the mobile phone and given by the base station is consistent with the information of the frequency band of the operator desired by the mobile terminal, the mobile terminal works in the second operative state. When the radio-frequency signal which is given by the base station and received by the mobile terminal is consistent with the information of the frequency band of the operator desired by the SIM card of the mobile terminal, registering to the network for the mobile terminal working properly.

In summary, a mobile terminal switching antenna and a switching method thereof provided by the present invention include the antenna, the RF module, the baseband chip, the voltage dividing module, the noise barrier module, the DC blocking module, the unidirectional conduction module, and the antenna matching module. The baseband chip is coupled to the antenna via the RF module. The baseband chip is coupled to the antenna sequentially via the voltage dividing module, the noise barrier module, and the DC blocking module. The baseband chip is grounded sequentially via the voltage dividing module, the noise barrier module, the unidirectional conduction module, and the antenna matching module. By the baseband chip not emitting or emitting the control signal to the antenna, the switching of the operative states of the antenna are thus realized, and the range of the frequency bands which can be received by the antenna is changed correspondingly, thereby greatly enhancing the receiving and transmitting performances of the mobile terminal antenna. Based on the enhancement of the receiving performance, users can still receive the signal well from the base station for calls in a place far from the base station, and based on the enhancement of the receiving performance, operating current of the RF transmission of the mobile terminal can be reduced to allow the battery to work longer, make the mobile terminal cooler, and providing convenience to the users.

It should be understood that applications of the present disclosure are not limited to what is described above. Those of ordinary skill in the art may make modifications or variations according to the above description, and all of these modifications and variations shall be covered within the scope of the attached claims of the present disclosure.

1. A mobile terminal switching antenna, comprising:
an antenna;
a radio-frequency (RF) module;
a baseband chip utilized to provide a control signal;
a voltage dividing module utilized to perform voltage division for the control signal;
a noise barrier module utilized to perform noise barrier for the control signal;
a direct current (DC) blocking module utilized to block a DC signal from entering the antenna;
a unidirectional conduction module utilized to unidirectionally conduct the control signal; and
an antenna matching module utilized to match and debug the antenna while switching the antenna;
wherein the baseband chip is coupled to the antenna via the RF module; the baseband chip is coupled to the antenna sequentially via the voltage dividing module, the noise barrier module, and the DC blocking module; and the baseband chip is grounded sequentially via the voltage dividing module, the noise barrier module, the unidirectional conduction module, and the antenna matching module.

2. The mobile terminal switching antenna according to claim 1, wherein the voltage dividing module comprises a first resistor; the baseband chip is coupled to the noise barrier module via the first resistor.

3. The mobile terminal switching antenna according to claim 1, wherein the noise barrier module comprises a first capacitor and a first inductor; the voltage dividing module is coupled to the DC blocking module via the first inductor; and the voltage dividing module is grounded via the first capacitor.

4. The mobile terminal switching antenna according to claim 1, wherein the DC blocking module comprises a second capacitor; one end of the second capacitor is coupled to the noise barrier module and the unidirectional conduction module, and the other end of the second capacitor is coupled to the antenna.

5. The mobile terminal switching antenna according to claim 1, wherein the unidirectional conduction module comprises an RF diode; an anode of the RF diode is respectively coupled to the noise barrier module and the DC blocking module, and a cathode of the RF diode is coupled to the antenna matching module.

6. The mobile terminal switching antenna according to claim 1, wherein the antenna matching module comprises a second inductor; one end of the second inductor is coupled to the unidirectional conduction module, and the other end is grounded.

7. The mobile terminal switching antenna according to claim 1, wherein the antenna has a switching point; one end of the switching point is coupled to the antenna, and the other end is coupled to the DC blocking module.

8. The mobile terminal switching antenna according to claim 2, wherein the antenna has a switching point; one end of the switching point is coupled to the antenna, and the other end is coupled to the DC blocking module.

9. The mobile terminal switching antenna according to claim 3, wherein the antenna has a switching point; one end of the switching point is coupled to the antenna, and the other end is coupled to the DC blocking module.

10. The mobile terminal switching antenna according to claim 4, wherein the antenna has a switching point; one end of the switching point is coupled to the antenna, and the other end is coupled to the DC blocking module.

11. The mobile terminal switching antenna according to claim 5, wherein the antenna has a switching point; one end of the switching point is coupled to the antenna, and the other end is coupled to the DC blocking module.

12. The mobile terminal switching antenna according to claim 6, wherein the antenna has a switching point; one end of the switching point is coupled to the antenna, and the other end is coupled to the DC blocking module.

13. The mobile terminal switching antenna according to claim 1, wherein when the baseband chip does not output the control signal, the antenna is in a first operative state which comprises a plurality of working frequency bands; when the baseband chip outputs the control signal, the antenna is in a second operative state which comprises another plurality of working frequency bands.

14. A switching method adopting the mobile terminal switching antenna according to claim 1, wherein the method comprises the following steps:
A, receiving the radio-frequency signal given by a base station and scanning each frequency band by a mobile terminal;
B, determining whether the currently scanned frequency band is in a plurality of working frequency bands, which are comprised in a first operative state of the antenna when the baseband chip does not output the control signal, if so, then performing step C; if not, then performing step D;
C, working in the first operative state by the antenna of the mobile terminal, and when the radio-frequency signal which is given by the base station and received by the mobile terminal is consistent with information of the frequency band of an operator desired by a SIM card of the mobile terminal, registering to a network for the mobile terminal working properly; and
D, outputting the control signal by the baseband chip, the antenna of the mobile terminal being in a second operative state which comprises another plurality of working frequency bands, and scanning each of the frequency bands individually by the mobile terminal, when the radio-frequency signal which is given by the base station and received by the mobile terminal is consistent with the information of the frequency band of the operator desired by the SIM card of the mobile terminal, registering to the network for the mobile terminal working properly.
